(19) United States
(12) Patent Application Publication
(10) Pub. No.: US 2024/0272435 A1
(43) Pub. Date: Aug. 15, 2024

(54) Sidewall Structures in a Head-Mounted Device

(71) Applicant: Apple Inc., Cupertino, CA (US)

(72) Inventors: Simon Fortin-Deschenes, Santa Clara, CA (US); Amanda K Abramson, Napa, CA (US); Luke A Pillans, San Diego, CA (US); Nicholas C Soldner, Los Altos, CA (US)

(21) Appl. No.: 18/472,138

(22) Filed: Sep. 21, 2023

Related U.S. Application Data
(60) Provisional application No. 63/484,427, filed on Feb. 10, 2023.
(60) Provisional application No. 63/497,622, filed on Apr. 21, 2023.

(51) Int. Cl. G02B 27/01

(52) U.S. Cl. CPC G02B 27/0172; G02B 27/0176; G02B 2027/0118; G02B 2027/0138

(57) ABSTRACT

A head-mounted device may include a component such as a sidewall structure that is switchable between an opaque mode and a transparent mode. In the opaque mode, the component may block ambient light from passing into the interior of the head-mounted device (such that the user cannot see the surrounding environment). In the transparent mode, the component may allow ambient light to pass into the interior of the head-mounted device (such that the user can see portions of the surrounding environment). The opaque mode may provide a more immersive experience for the user of the head-mounted device, whereas the transparent mode may allow the user to see objects in their surrounding physical environment. Instead or in addition, the head-mounted device may include one or more sidewall displays.

This application claims the benefit of U.S. Provisional Patent Application No. 63/484,427, filed Feb. 10, 2023, and U.S. Provisional Patent Application No. 63/497,622, filed Apr. 21, 2023, which are hereby incorporated by reference herein in their entireties.

### FIELD

This relates generally to electronic devices, and, more particularly, to electronic devices such as head-mounted devices.

### BACKGROUND

Electronic devices such as head-mounted devices may have displays for displaying images. The displays may be housed in a head-mounted support structure.

### SUMMARY

A head-mounted device may include left and right optical modules configured to display images and a head-mounted support structure coupled to the left and right optical modules. The head-mounted support structure may include a flexible portion that is configured to conform to a face when the head-mounted support structure is worn, a rigid portion that is separated from the flexible portion by a gap, and sidewall structures that bridge the gap between the rigid portion and the flexible portion. A portion of the sidewall structures may have an adjustable transparency.

A head-mounted device may have first and second opposing sides and may include a first structure on the first side of the head-mounted device, a second structure on the second side of the head-mounted device that at least partially surrounds a central opening, a sidewall structure that extends between the first structure and the second structure and that has an adjustable transparency, and left and right optical modules configured to display images that are viewable through the central opening.

A head-mounted device may include left and right optical modules configured to display images, a flexible structure that is configured to conform to a face, a rigid structure that is separated from the flexible structure by a gap, and sidewall structures that bridge the gap between the rigid structure and the flexible structure. The left and right optical modules may be viewable through a central opening defined by the flexible structure and the sidewall structures may include a sidewall display that is viewable through the central opening.

### BRIEF DESCRIPTION OF THE DRAWINGS

FIG. 1 is a top view of an illustrative electronic device such as a head-mounted device in accordance with some embodiments.

FIG. 2 is top view of an illustrative optical module for an electronic device in accordance with some embodiments.

FIG. 3 is a cross-sectional top view of an illustrative head-mounted device with light seal structures and support posts in accordance with some embodiments.

FIG. 4 is a perspective view of an illustrative head-mounted device with light seal structures and support posts in accordance with some embodiments.

FIG. 5 is a cross-sectional side view of an illustrative head-mounted device with light seal structures and support posts in accordance with some embodiments.

FIG. 6 is a cross-sectional rear view of an illustrative head-mounted device with sidewall structures having adjustable transparencies in accordance with some embodiments.

FIG. 7 is a cross-sectional side view of an illustrative head-mounted device with sidewall structures having adjustable transparencies in accordance with some embodiments.

FIG. 8A is a top view of an illustrative sidewall structure that includes an electrochromic layer in accordance with some embodiments.

FIG. 8B is a top view of an illustrative sidewall structure that includes a liquid crystal layer in accordance with some embodiments.

FIG. 8C is a side view of an illustrative sidewall structure that includes stretchable fabric in accordance with some embodiments.

FIG. 8D is a side view of an illustrative sidewall structure that includes rotating blinds in accordance with some embodiments.

FIG. 8E is a side view of an illustrative sidewall structure that includes a chamber with transparent walls that is selectively filled with opaque liquid in accordance with some embodiments.

FIG. 9 is a schematic diagram of an illustrative head-mounted device with sidewall structures having adjustable transparencies in accordance with some embodiments.

FIG. 10 is a side view of an illustrative sidewall structure that includes individually controllable zones in accordance with some embodiments.

FIG. 11 is a cross-sectional rear view of an illustrative head-mounted device with sidewall displays in accordance with some embodiments.

FIG. 12 is a cross-sectional side view of an illustrative head-mounted device with sidewall displays in accordance with some embodiments.

### DETAILED DESCRIPTION

A head-mounted device may include a head-mounted support structure that allows the device to be worn on the head of a user. The head-mounted device may have displays that are supported by the head-mounted support structure for presenting a user with visual content. The head-mounted device may also have sensors such as front-facing cameras and other sensors for gathering information on the environment surrounding the device.

The head-mounted device may include a component such as a sidewall structure that is switchable between an opaque mode, a transparent mode, and/or a partially transparent mode. In the opaque mode, the component may block ambient light from passing into the interior of the head-mounted device (such that the user cannot see the surrounding environment). In the transparent mode, the component may allow ambient light to pass into the interior of the head-mounted device (such that the user can see portions of the surrounding environment). The opaque mode may provide a more immersive experience for the user of the head-mounted device, whereas the transparent mode may allow the user to see objects in their surrounding physical environment.

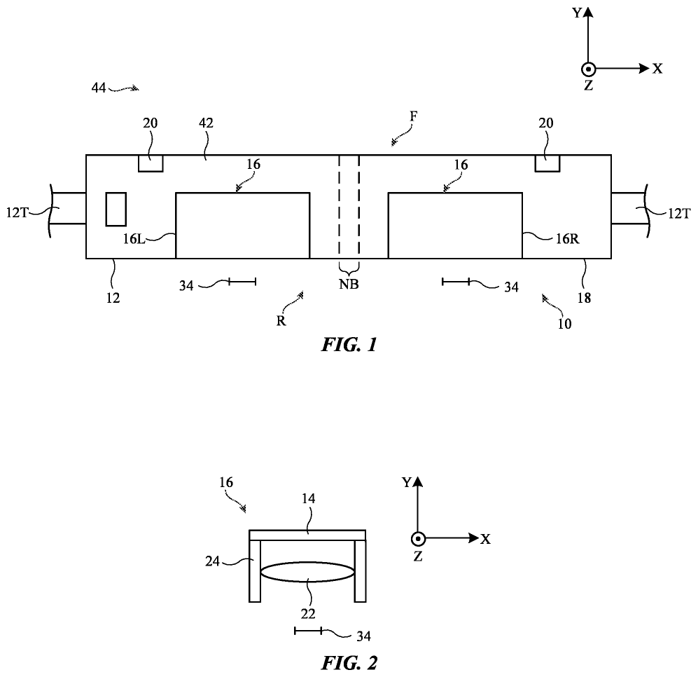

FIG. 1 is a top view of an illustrative head-mounted electronic device. As shown in FIG. 1, head-mounted device 10 may include housing 12. Housing 12 is configured to be worn on a user's head and may sometimes be referred to as a head-mounted housing or head-mounted support structure. Housing 12 may have curved head-shaped surfaces, a nose-bridge portion such as portion NB that is configured to rest on a user's nose when device 10 is on a user's head, may have a strap 12T for supporting device 10 on the user's head, and/or may have other features that allow device 10 to be worn by a user. Housing 12 may have walls or other structures that separate an interior region of device 10 such as interior region 42 from an exterior region surrounding device 10 such as exterior region 44. Electrical components 40 (e.g., integrated circuits, sensors, control circuitry, light-emitting diodes, lasers, and other light-emitting devices, other control circuits and input-output devices, etc.) may be mounted on printed circuits and/or other structures within device 10 (e.g., in interior region 42).

To present a user with images for viewing from eye boxes such as eye box 34, device 10 may include rear-facing displays in optical modules 16. There may be, for example, a left rear-facing display in left optical module 16L for presenting an image through a left lens to a user's left eye in a left eye box and a right rear-facing display in right optical module 16R for presenting an image through a right lens to a user's right eye in a right eye box.

The user's eyes are located in eye boxes 34 at rear side R of device 10 when inwardly facing surface 18 of housing 12 rests against the outer surface of the user's face. On rear side R, housing 12 may have cushioned structures (sometimes referred to as light seal structures) to enhance user comfort as surface 18 rests against the user's face.

Device 10 may have forward-facing components such has forward-facing cameras 20 on front side F that face outwardly away from the user. Cameras 20 may generally be oriented in the +Y direction of FIG. 1. If desired, the left-hand camera may face slightly to the left and the right-hand camera may face slightly to the right to enhance the overall coverage of cameras 20. During operation, images captured by cameras 20 (sometimes referred to as pass-through video and/or pass-through images) and/or computer-generated content such as text, graphics, etc. may be displayed for the user by displays in modules 16.

FIG. 2 is a cross-sectional top view of an illustrative optical module. As shown in FIG. 2, optical module 16 may include display 14 and lens 22 mounted in optical module housing 24. Display 14 presents images in eye box 34. Each optical module may have structures of the type shown in FIG. 2 (e.g., with one display per optical module). Alternatively, a single display may span both optical modules, with a first portion of the display providing images for the left optical module and a second portion of the display providing images for the right optical module.

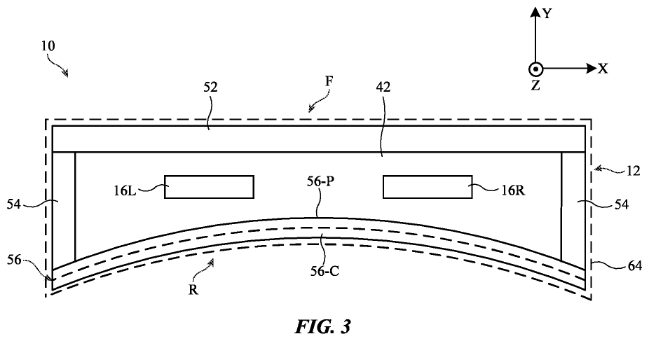

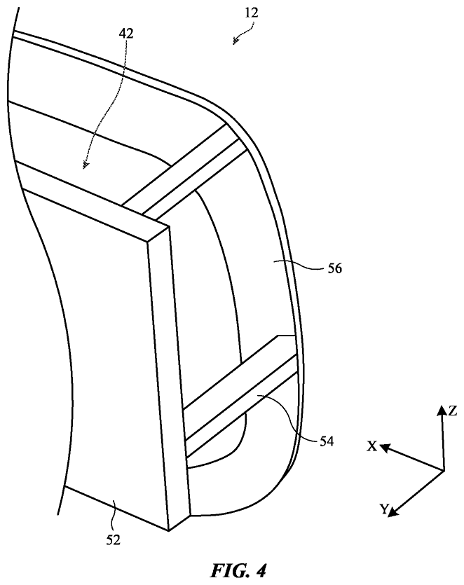

FIG. 3 is a cross-sectional top view of an illustrative head-mounted device with a textile layer. As shown in FIG. 3, head-mounted support structure 12 may include a rigid front structure 52 (sometimes referred to as front portion 52, rigid structure 52, etc.) at the front side F of the head-mounted device. Head-mounted support structure 12 additionally includes support posts 54 (sometimes referred to as rigid support posts 54, rigid sidewall portions 54, side portions 54, sidewall portions 54, support structures 54, etc.) and flexible rear structure 56. The support structures 54 extend from the front portion 52 towards the rear side R. The support structures 54 may couple the front portion 52 to flexible rear portion 56 (sometimes referred to as flexible structure 56, flexible ring 56, flexible light seal structure 56, etc.) of the head-mounted support structure. Interior 42 (with associated optical modules 16L/16R and other electronic components) is formed in the volume between front structure 52 and rear structure 56.

In one possible arrangement, support structure 12 includes a sidewall that extends from front structure 52 in the negative Y-direction continuously around the perimeter of the front structure 52. Alternatively, to minimize the weight of the head-mounted support structure, discrete support posts 54 may be dispersed around the perimeter of the front structure 52. The support posts are each coupled between the rigid front structure 52 and the flexible rear structure 56. Air-filled gaps (or gaps filled with another desired filler material) may separate adjacent support posts.

Front structure 52 may be an opaque structure that extends across the entire front side of device 10. Alternatively, front structure 52 may be a ring-shaped structure that extends in a ring around the front side of device 10. Flexible rear structure 56 may be a ring-shaped structure that extends in a ring around some or all of the rear side of device 10. Flexible rear structure 56 may be ring-shaped (with a central opening) to allow the user to view optical modules 16 (through the central opening) while device 10 is worn by the user. Flexible rear structures 56 (sometimes referred to as light seal structures) may include a flexible plastic structure 56-P and/or a cushion 56-C. The cushion may optionally be a removable cushion.

When head-mounted device 10 is worn on the head of a user, the flexible rear structure(s) 56 may conform to the user's face. To provide an immersive experience to the viewer and preserve high contrast in the display viewed by the user during operation, it may be desirable to block ambient light from reaching the user's eyes. This ensures the only light viewed by the user is from the display in the head-mounted device. Light seal structures 56 may be sufficiently flexible and/or compressible to conform to a user's face during operation, preventing stray light from entering the head-mounted device.

Flexible rear structures 56 may include a flexible plastic structure 56-P. The flexible plastic structure 56-P may be sufficiently flexible to conform to the shape of a user's face when worn by the user. However, the flexible plastic structure may have sufficient rigidity to hold its shape while being worn (e.g., and does not bias towards or away from the user's face while being worn). The flexible plastic structure may not be compressible. In contrast, the flexible rear structures 56 may also include a cushion 56-C that is compressible. The cushion 56-C may also be sufficiently flexible to conform to the shape of a user's face when worn by the user. The compressible cushion may be pressed against the user's face to form a tight light seal while still remaining comfortable for the user.

Head-mounted support structure 12 may optionally be covered on one or more sides by a textile layer 64 (sometimes referred to as fabric layer 64). Textile layer 64 may be formed from an opaque or light-shielding material (e.g., black yarn) or may formed from an underlying material coated with an opaque or light-shielding material (e.g., black dye or ink). The textile layer 64 may be formed by a woven fabric or a nonwoven fabric. As examples, the textile layer 64 may be formed from any suitable type of fabric such as knit fabric, woven fabric, braided fabric, etc.

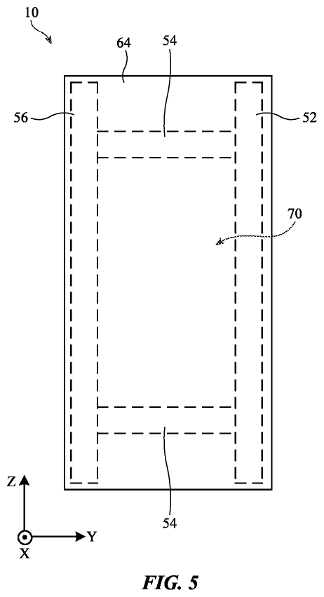

FIG. 4 is a perspective view of head-mounted support structure 12. As shown, front structure 52 covers the entire front side of the head-mounted device (e.g., front structure 52 does not have a central opening). In contrast, flexible rear structure 56 is ring-shaped with a central opening. The user may view optical modules 16 through the central opening while using the head-mounted device. As shown in FIG. 4, support posts 54 connect the flexible rear structure 56 to rigid front structure 52. Interior volume 42 (with associated optical modules 16 and other electronic components) is formed between front structure 52 and rear structure 56. Any desired number of support structures may be included in the device. The support structures may be distributed around the periphery of the device to ensure that the central opening with optical modules 16 is not blocked.

Each support structure may optionally be attached to the flexible structure 56 using a pivoting portion with a spherical joint. The spherical joint may allow for the flexible structure 56 to be pressed against the user's face at any desired angle, allowing the flexible structure 56 to conform to the user's face as much as possible (promoting a tight light seal).

It should be noted that head-mounted support structure 12 in FIG. 4 may also be covered by textile layer 64, similar to as shown and discussed in connection with FIG. 3. The textile layer is omitted from FIG. 4 so as to not obfuscate the drawing.

When textile layer 64 is included, the textile layer may form a continuous cover over support posts 54, air gaps between the support posts, and/or front structure 52. The textile layer therefore covers a space (gap) between front structure 52 and rear structure 56. A portion of the textile layer between front structure 52 and rear structure 56 (e.g., that fills the gap between front structure 52 and rear structure 56) may sometimes be referred to as a sidewall structure.

FIG. 5 is a cross-sectional side view of an illustrative head-mounted device 10 with a textile layer 64. As shown in FIG. 5, textile layer 64 is formed over and covers at least portions of rear structure 56, front structure 52, and support posts 54. A portion of textile layer 64 therefore serves as a sidewall structure 70 that extends between rear structure 56 and front structure 52. The textile layer 64 may improve the aesthetic appearance and tactile feel of device 10 by covering the underlying components (e.g., rear structure 56, front structure 52, and support posts 54) and providing a uniform layer on the exterior of device 10.

In the example of FIG. 5, textile layer 64 blocks ambient light from passing from the exterior of the device to the interior of the device. This provides head-mounted device 10 with as immersive an environment as possible (because the user will not be distracted by ambient light from their physical environment when operating device 10). The textile layer 64 works in combination with light seal structures 56 to provide a dark environment in which the user views images. The sidewall 70 of textile layer 64 may therefore also sometimes be referred to as a light seal structure. In the example of FIG. 5, textile layer 64 has a fixed transparency (e.g., less than 20%, less than 10%, less than 5%, etc.) determined by the properties of the textile.

It may be desirable for sidewall structures in head-mounted device 10 (e.g., structures that extend between rear structure 56 and front structure 52) to instead have an adjustable transparency. For example, a sidewall structure may be operable in at least two modes. In a first mode, the sidewall structure may have a relatively low transparency (e.g., less than 20%, less than 10%, less than 5%, etc.). In this mode, the sidewall structure blocks ambient light and contributes to the light seal for the head-mounted device. In a second mode, the sidewall structure may have a relatively high transparency (e.g., greater than 80%, greater than 90%, greater than 95%, etc.). In this mode, the sidewall structure passes ambient light and allows the user to view portions of their physical environment.

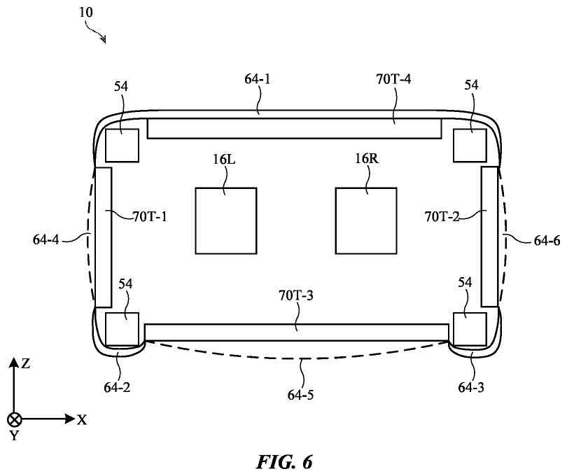

FIG. 6 is a cross-sectional rear view of an illustrative head-mounted device with sidewall structures having adjustable transparency. As shown in FIG. 6, adjustable transparency sidewall structures 70T-1, 70T-2, 70T-3, and 70T-4 are interposed between various support posts 54 in head-mounted device 10. Each adjustable transparency sidewall structure 70T may extend between the rear structure 56 and front structure 52.

Each adjustable transparency sidewall structure has an adjustable transparency. Each adjustable transparency sidewall structure 70T may be adjusted between two fixed transparencies (e.g., one high transparency mode and one low transparency mode) or may be adjustable to any target transparency within a range of transparencies. In other words, the sidewall structure may have a maximum transparency and a minimum transparency. The sidewall structure may be operable at only the minimum and maximum transparencies or may be adjusted to have any intermediate transparency between the maximum and minimum transparencies.

In FIG. 6, three discrete adjustable transparency sidewall structures are shown. A first sidewall structure 70T-1 extends along a left edge of the head-mounted device. A second sidewall structure 70T-2 extends along a right edge of the head-mounted device. A third sidewall structure 70T-3 extends along a bottom edge of the head-mounted device. A fourth sidewall structure 70T-4 extends along a top edge of the head-mounted device. Each adjustable transparency sidewall structure may be controlled individually (e.g., different sidewall structures may be controlled to have different transparencies) or the different sidewall structures may be controlled in unison (e.g., the different sidewall structures always have the same transparency). Herein, structures that extend between the front F and rear R of head-mounted device 10 may be referred to as sidewall structures regardless of whether they are positioned along the top edge, bottom edge, left edge, or right edge of the head-mounted device (e.g., when viewed from the front as in FIG. 6).

Although shown in FIG. 6 as one sidewall structure, sidewall structure 70T-3 may optionally be split into two discrete sidewall structures (e.g., with one sidewall structure on each side of the user's nose). Including adjustable transparency sidewall structure 70T-3 along the bottom edge of the head-mounted device (e.g., on either side of the user's nose) may be useful in helping the user navigate their physical environment while wearing head-mounted device 10.

The example in FIG. 6 of including four discrete adjustable transparency sidewall structures is merely illustrative. In general, the head-mounted device may have any desired number of adjustable transparency sidewall structures (e.g., along the left edge, the right edge, the bottom edge, and/or the top edge of the head-mounted device). Additionally, instead of forming discrete adjustable transparency sidewall structures along different edges, a unitary adjustable transparency sidewall structure may be formed along multiple edges of the head-mounted device. In other words, a single continuous adjustable transparency sidewall structure may be formed along the left edge, the right edge, the bottom edge, and/or the upper edge of the head-mounted device. The single continuous adjustable transparency sidewall structure may be flexible and may include one or more bends.

Each adjustable transparency sidewall structure may have a uniform transparency or may be split into discrete zones with individually controllable transparencies.

FIG. 6 shows an example where, in combination with sidewall structures 70T, a textile layer 64 forms exterior surfaces of head-mounted device 10. A first textile layer portion 64-1 is formed along the upper edge of the device, an upper-left corner of the device, and an upper-right corner of the device between sidewall structures 70T-1 and 70T-2 (and overlapping sidewall structure 70T-4). A second textile layer portion 64-2 is formed along a lower-left corner of the device between sidewall structures 70T-1 and 70T-3. A third textile layer portion 64-3 is formed along a lower-right corner of the device between sidewall structures 70T-2 and 70T-3. The textile layer portions 64-1, 64-2, and 64-3 may be formed from the same material or from different materials.

As shown in FIG. 6, the sidewall structures 70T-1, 70T-2, and 70T-3 may have portions that are non-overlapping with textile layer portions 64-1, 64-2, and 64-3. Sidewall structures 70T-1, 70T-2, and 70T-3 therefore form some of the exterior surfaces of head-mounted device 10.

The arrangement of the textile layer in FIG. 6 is merely illustrative. If desired, textile layers may optionally overlap sidewall structures 70T. FIG. 6 explicitly shows textile layer portion 64-1 overlapping sidewall structure 70T-4 (though it is noted that the textile layer may be omitted over sidewall structure 70T-4 if desired). As shown in FIG. 6, textile layer portion 64-4 may optionally overlap sidewall structure 70T-1, textile layer portion 64-5 may optionally overlap sidewall structure 70T-3, and textile layer portion 64-6 may optionally overlap sidewall structure 70T-2. The textile layer portions over the sidewall structures may serve as cosmetic layers. The cosmetic layers may have a fixed transparency that is greater than 30%, greater than 50%, greater than 70%, greater than 80%, etc. The cosmetic layers may have a preferred aesthetic appearance over the sidewall structures 70T while still enabling adjustable transparency functionality in the underlying sidewall structures 70T.

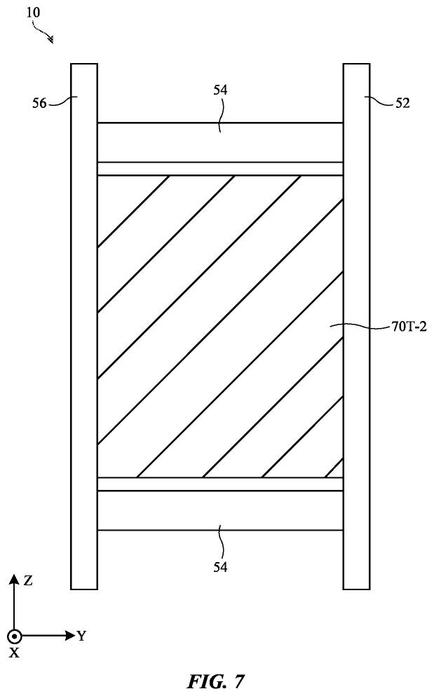

FIG. 7 is a side view of an illustrative head-mounted device with sidewall structures having adjustable transparency. The textile layer is omitted from FIG. 7 so as to not obfuscate the drawing. As shown in FIG. 7, sidewall structure 70T-2 may extend between rear structure 56 and front structure 52. The sidewall structure 70T-2 therefore extends away from front structure 52 and towards rear structure 56 in a direction that is approximately (e.g., within 10 degrees of) orthogonal to the plane that includes the front structure 52 (e.g., the XZ-plane). The sidewall structure 70T-2 also extends away from rear structure 56 and towards front structure 52 in a direction that is approximately (e.g., within 10 degrees of) orthogonal to the plane that includes the rear structure 56 (e.g., the XZ-plane).

Any desired structures may be used to form each sidewall structure 70T. As some examples, sidewall structures 70T may include one or more of an electrochromic layer, a liquid crystal layer, stretchable fabric, sliding mechanical blinds, rotating mechanical blinds, a chamber with transparent walls that is selectively filled with opaque liquid, etc.

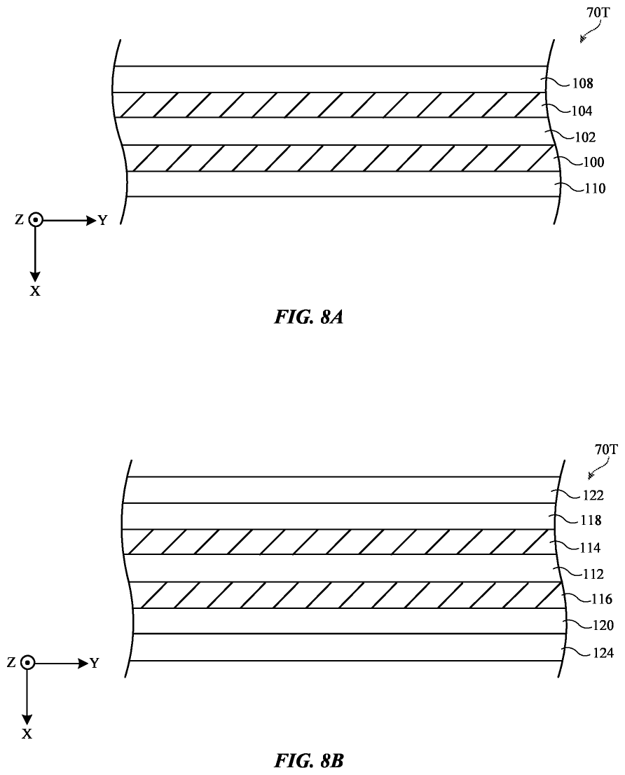

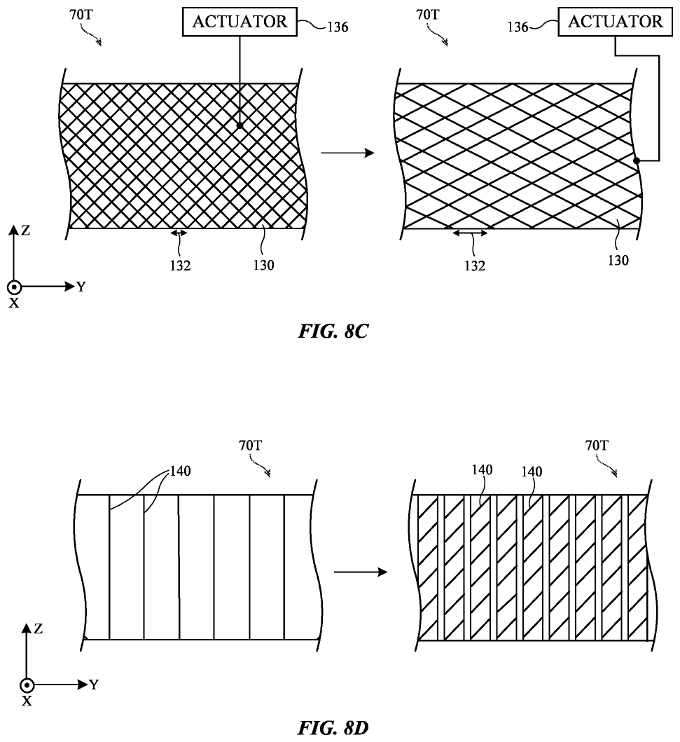

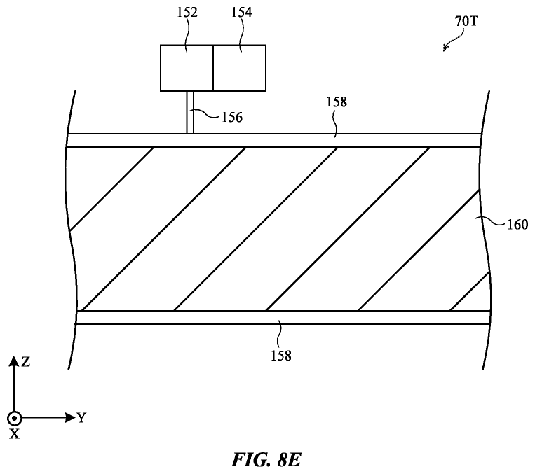

FIG. 8A shows a top view of an illustrative sidewall structure 70T formed using an electrochromic layer. As shown, one or more functional layers 102 (including, for example, electrochromic layers, electrolyte layers, etc.) is interposed between first and second transparent conductive layers 104 and 106. The transparent conductive layers 104 and 106 may be formed by, as an example, indium tin oxide. Transparent substrates 108 and 110 (e.g., formed from glass) may also be included on either side of the structure. Voltage may be applied to one or both of transparent conductive layers 104 and 106 to adjust the transparency of the sidewall structure 70T in FIG. 8A.

FIG. 8B shows a top view of an illustrative sidewall structure 70T formed using a liquid crystal layer. As shown, a liquid crystal layer 112 is interposed between first and second transparent conductive layers 114 and 116. The transparent conductive layers 114 and 116 may be formed by, as an example, indium tin oxide. Transparent substrates 118 and 120 (e.g., formed from glass) may also be included on either side of the liquid crystal layer. A first linear polarizer 122 may be formed on one side of the liquid crystal layer and a second linear polarizer 124 may be formed on the other side of the liquid crystal layer. Voltage may be applied to one or both of transparent conductive layers 114 and 116 to adjust the transparency of the sidewall structure 70T in FIG. 8B.

FIG. 8C shows a side view of an illustrative sidewall structure 70T formed using a stretchable fabric. As shown in FIG. 8C, stretchable fabric 130 may have openings with a characteristic dimension 132 in an unstretched state (on the left in FIG. 8C). One or more actuators 136 may be connected to the fabric 130 and configured to selectively stretch the fabric. On the right side of FIG. 8C, actuator 136 has been used to stretch fabric 130. In the stretched state, the fabric has openings with a characteristic dimension 134 that is greater than the characteristic dimension 132. In other words, stretching the fabric increases the size of the openings in the fabric and correspondingly increases the transparency of the fabric.

FIG. 8D shows a side view of an illustrative sidewall structure 70T formed using rotating blinds. As shown in FIG. 8D, the sidewall structures may include a plurality of slats 140. In a first state (to maximize transparency), depicted on the left side of FIG. 8D, the slats are orientated parallel with the XZ-plane. The majority of ambient light is allowed to pass through the sidewall structures in this state. In a second state (to minimize transparency), depicted on the right side of FIG. 8D, the slats are orientated parallel with the YZ-plane. The majority of ambient light is blocked from passing through the sidewall structures in this state. One or more actuators may be included to rotate the slats as desired to adjust the transparency of sidewall structures 70T.

FIG. 8E shows a side view of an illustrative sidewall structure 70T formed using a chamber with transparent walls that is optionally filled with opaque liquid. As shown in FIG. 8E, walls 158 may define a chamber. Opaque liquid 160 may optionally be pumped into the chamber from fluid reservoir 152 by pump 154. When the opaque liquid is pumped into the chamber to fill the chamber, the sidewall structures will be opaque. When the opaque liquid is withdrawn to the fluid reservoir 152, the sidewall structures will be transparent. A channel 156 may be used to move the liquid 160 in and out of the chamber.

Each adjustable transparency sidewall structure from FIGS. 8A-8E may optionally be split into discrete zones (sometimes referred to as pixels) with individually controllable transparencies.

It is noted that any of the sidewall structures 70T from FIGS. 8A-8E may be stacked next to each other along a single sidewall if desired. As a specific example, a sidewall structure 70T may include a pixelated liquid crystal layer (e.g., with the cross-sectional of FIG. 8B) that is covered by a stretchable fabric (e.g., as shown in FIG. 8C). Light entering head-mounted device may pass through the stretchable fabric and then the pixelated liquid crystal layer. Combining multiple layers with variable transparency in this manner may allow for sidewall structure 70T to have desired display functionality, meet targets for minimum transparency and maximum transparency, and provide an aesthetically pleasing appearance on the outer surface of the sidewall structure.

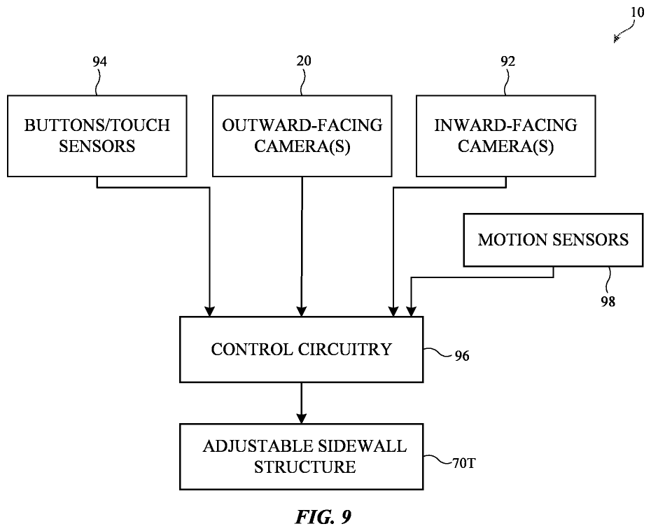

FIG. 9 is a schematic diagram of an illustrative head-mounted device with adjustable sidewall structures. As shown, the head-mounted device may include control circuitry such as control circuitry 96 that controls the adjustable sidewall structures. Control circuitry 96 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 96 may be used to control the operation of device 10. The processing circuitry may be based on one or more microprocessors, microcontrollers, digital signal processors, baseband processors, power management units, audio chips, application specific integrated circuits, etc.

Control circuitry 96 may control the adjustable sidewall structures 70T based on a variety of factors. As shown in FIG. 9, the control circuitry may receive data from outward-facing camera(s) 20, inward-facing camera(s) 92, buttons and/or touch sensors 94, motion sensors 98, and/or any other desired components. The outward-facing camera(s) 20 may capture images of the physical environment surrounding the user. The inward-facing camera(s) 92 may capture images of the user (e.g., for gaze detection). The buttons and/or touch sensors 94 may receive additional user input from the user of head-mounted device 10. The motion sensors 98 (e.g., accelerometers) may detect movement of device 10 (and, correspondingly, the user's head).

Control circuitry 96 may adjust the transparency of one or more adjustable sidewall structures 70T in response to user selection. In other words, the user may use one or more components (such as buttons and/or touch sensors 94) to provide user input indicating the user desires a change in the transparency of structures 70T. Control circuitry 96 then adjusts the transparency of one or more adjustable sidewall structures 70T according to the user input.

Instead or in addition, control circuitry 96 may adjust the transparency of one or more adjustable sidewall structures 70T in response to a detected context (e.g., based on an application running on the head-mounted device and/or information from the application running on the head-mounted device). In other words, control circuitry 96 may evaluate the current context of the head-mounted device and adjust the transparency of structures 70T accordingly. As an example, the control circuitry 96 may detect that a user is viewing a movie using head-mounted device 10 (e.g., based on an application running on the head-mounted device and/or information from the application running on the head-mounted device). When control circuitry 96 detects the user is viewing a movie, the control circuitry 96 may reduce the transparency of the adjustable sidewall structures to maximize the immersion for the user. In another example, the control circuitry 96 may detect that a user is exercising (e.g., based on an application running on the head-mounted device and/or information from the application running on the head-mounted device). When control circuitry 96 detects the user is exercising, the control circuitry 96 may increase the transparency of the adjustable sidewall structures to improve the user's peripheral vision.

Instead or in addition, control circuitry 96 may adjust the transparency of one or more adjustable sidewall structures 70T in response to information from outward-facing camera(s) 20. For example, outward-facing camera(s) 20 may capture images of an object or person approaching the user. In this case, the control circuitry 96 may increase the transparency of the adjustable sidewall structures to improve the user's peripheral vision.

Instead or in addition, control circuitry 96 may adjust the transparency of one or more adjustable sidewall structures 70T in response to gaze-tracking information from inward-facing camera(s) 92, head-tracking information from motion sensors 98, and/or hand-tracking information from outward-facing camera(s) 20.

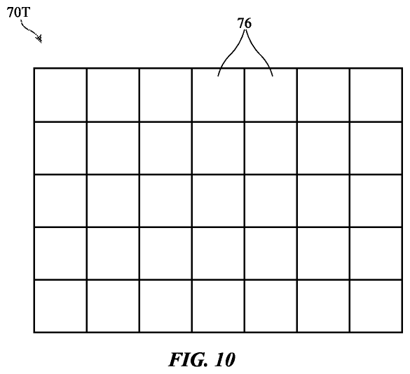

As previously mentioned, a single adjustable sidewall structure may have a plurality of discrete zones. FIG. 10 is a side view of an illustrative adjustable sidewall structure 70T with a plurality of discrete zones 76. In FIG. 10, there are seven columns and five rows of zones, resulting in thirty-five total zones. This example is merely illustrative. In general, a given adjustable sidewall structure 70T may have 1 zone, 2 zones, more than 2 zones, more than 10 zones, more than 50 zones, more than 100 zones, more than 1000 zones, more than 2000 zones, more than 4000 zones, etc. Control circuitry 96 may adjust the transparency of each zone individually.

In one example, zones of an adjustable sidewall structure may be controlled to block the user's physical environment while allowing the user's body (e.g., the user's arms, hands, and/or torso) to be visible. Images from cameras 20 and/or 92 may be used by control circuitry 96 to determine the position of the user's body and the corresponding zones that should be made transparent to allow the user's body to be visible.

In another example, zones of an adjustable sidewall structure may be controlled to block bright external light sources that would otherwise cause glare on optical modules 16L and 16R. Ray tracing, the position of the bright external light sources as determined using camera(s) 20, and/or the position of the user's head as determined using motion sensors 98 may be used to determine which zones to make opaque to block the bright external light sources.

In yet another example, zones of an adjustable sidewall structure may be controlled to match the tone mapping, dynamic range, and/or brightness of the display system in the head-mounted device.

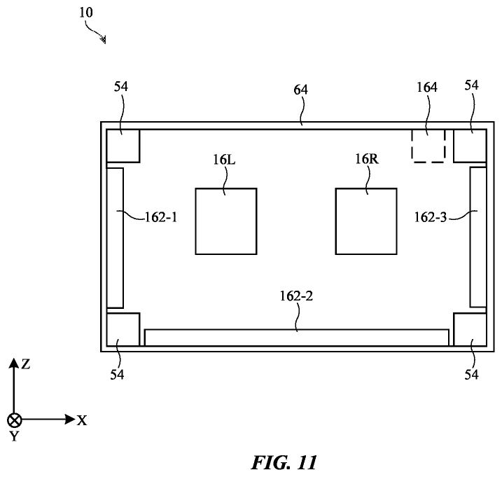

Instead or in addition of including adjustable transparency sidewall structures, head-mounted device 10 may include one or more sidewall displays. FIG. 11 is a cross-sectional rear view of an illustrative head-mounted device with sidewall displays. As shown in FIG. 11, sidewall displays 162-1, 162-2, and 162-3 are interposed between various support posts 54 in head-mounted device 10. Each sidewall display 162 may extend between the rear structure 56 and front structure 52. Each sidewall display 162 emits light towards the interior of the head-mounted device such that the sidewall displays are viewable by a user wearing the head-mounted device (e.g., through a central opening defined by structure 56).

In FIG. 11, three discrete sidewall displays are shown. A first sidewall display 162-1 extends along a left edge of the head-mounted device. A second sidewall display 162-2 extends along a bottom edge of the head-mounted device. A third sidewall display 162-3 extends along a right edge of the head-mounted device. Control circuitry within head-mounted device 10 (e.g., control circuitry 96 in FIG. 10) may be used to control the content presented on each display.

The example in FIG. 11 of having three discrete sidewall displays is merely illustrative. In general, the head-mounted device may have any desired number of sidewall displays (e.g., along the left edge, the right edge, the bottom edge, and/or the upper edge of the head-mounted device). Additionally, instead of forming discrete sidewall displays along different edges, a unitary sidewall display may be formed along multiple edges of the head-mounted device. In other words, a single continuous sidewall display may be formed along the left edge, the right edge, the bottom edge, and/or the upper edge of the head-mounted device. The single continuous sidewall display may be flexible and may have one or more bends.

FIG. 11 shows an example where a textile layer 64 overlaps the sidewall displays 162 and forms exterior surfaces of head-mounted device 10. In other words, sidewall displays 162 are positioned within the interior of head-mounted device 10. This example is merely illustrative and textile layer 64 may instead be omitted if desired.

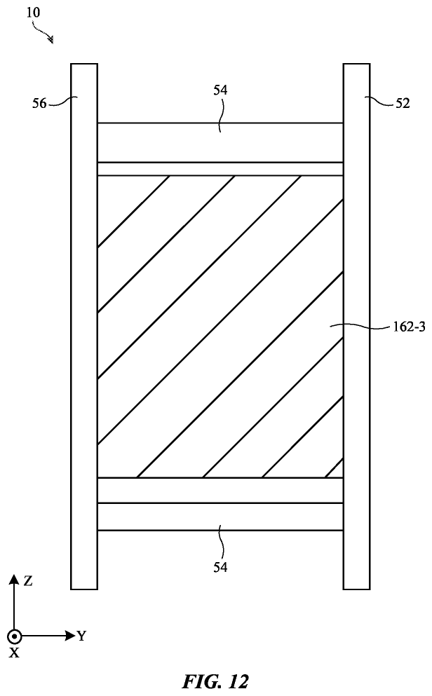

FIG. 12 is a side view of an illustrative head-mounted device with sidewall displays. The textile layer from FIG. 11 is omitted from FIG. 12 so as to not obfuscate the drawing. As shown in FIG. 12, sidewall display 162-3 may extend between rear structure 56 and front structure 52. The sidewall display 162-3 therefore extends away from front structure 52 and towards rear structure 56 in a direction that is approximately (e.g., within 10 degrees of) orthogonal to the plane that includes the front structure 52 (e.g., the XZ-plane). The sidewall display 162-3 also extends away from rear structure 56 and towards front structure 52 in a direction that is approximately (e.g., within 10 degrees of) orthogonal to the plane that includes the rear structure 56 (e.g., the XZ-plane).

Each sidewall display may be formed using any desired display technology. For example, the sidewall displays may include organic light-emitting diode (OLED) display panels, liquid crystal display (LCD) panels, light-emitting diode (LED) display panels such as microLED display panels, projection-based displays (e.g., using the optional light projector 164 depicted in FIG. 11 that emits light towards the viewable area of the display), etc. The sidewall display may include a diffraction grating and/or waveguide. Light sources (e.g., light-emitting diodes) for the sidewall display may optionally be integrated into textile layer 64.

The sidewall display may have a lower resolution and/or pixel density than the displays in optical modules 16L and 16R. The sidewall display may have a pixel density of less than 400 pixels per inch (PPI), less than 200 pixels per inch (PPI), less than 100 pixels per inch (PPI), less than 50 pixels per inch (PPI), less than 10 pixels per inch (PPI), etc.

The sidewall displays may be used to display images of the user's physical environment (e.g., pass-through images to simulate the area covered by the sidewall displays being transparent). Images from outward-facing cameras within head-mounted device 10 may be used to display the images of the physical environment on the sidewall displays.

The sidewall displays may also be used to display computer-generated content such as text, graphics, etc. The computer-generated content may match the computer-generated content on the displays in optical modules 16L/16R such that the user perceives the sidewall displays as extensions of the displays in optical modules 16L/16R. This effectively increases the field-of-view of the displays (for the left and right eyes) in optical modules 16L/16R.

In one possible arrangement, the sidewall displays may have a higher refresh rate than the displays in optical modules 16L/16R (e.g., by a factor of 2 or more, by a factor of 3 or more, by a factor of 4 or more, etc.). The refresh rate of the sidewall displays may be a multiple of the refresh rate of the displays in optical modules 16L/16R. A high refresh rate in the sidewall displays may improve user comfort when operating head-mounted device 10.

If desired, the resolution of the sidewall displays may vary as a function of visual acuity. For example, the human eye has lower resolution at increasingly high viewing angles. Accordingly, the resolution of a sidewall display may vary as a function of expected viewing angle for the user's eye(s). As another example, the resolution of sidewall displays along the left and/or right edges (e.g., displays 162-1 and 162-3 in FIG. 11) may be greater than the resolution of sidewall displays along the top and/or bottom edges (e.g., display 162-2 in FIG. 11).

A microlens array may optionally be formed over each sidewall display.

As described above, one aspect of the present technology is the gathering and use of information such as information from input-output devices. The present disclosure contemplates that in some instances, data may be gathered that includes personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to have control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of information that may include personal information data to implement one or more various disclosed embodiments, the present disclosure also contemplates that the various embodiments can also be implemented without the need for accessing personal information data. That is, the various embodiments of the present technology are not rendered inoperable due to the lack of all or a portion of such personal information data.

The foregoing is merely illustrative and various modifications can be made to the described embodiments. The foregoing embodiments may be implemented individually or in any combination.

What is claimed is:

1. A head-mounted device, comprising:
left and right optical modules configured to display images; and
a head-mounted support structure coupled to the left and right optical modules, the head-mounted support structure comprising:
a flexible portion that is configured to conform to a face when the head-mounted support structure is worn;
a rigid portion that is separated from the flexible portion by a gap; and
sidewall structures that bridge the gap between the rigid portion and the flexible portion, wherein a portion of the sidewall structures has an adjustable transparency.

2. The head-mounted device defined in claim 1, wherein the flexible portion at least partially surrounds a central opening.

3. The head-mounted device defined in claim 2, wherein the left and right optical modules are viewable through the central opening.

4. The head-mounted device defined in claim 2, wherein the portion of the sidewall structures having the adjustable transparency extends around the entire central opening.

5. The head-mounted device defined in claim 1, wherein first and second discrete portions of the sidewall structures have individually adjustable transparencies.

6. The head-mounted device defined in claim 1, further comprising:
a textile layer that covers at least a portion of the head-mounted support structure.

7. The head-mounted device defined in claim 6, wherein the textile layer overlaps the portion of the sidewall structures having the adjustable transparency.

8. The head-mounted device defined in claim 6, wherein the textile layer does not overlap the portion of the sidewall structures having the adjustable transparency and wherein the textile layer and the portion of the sidewall structures having the adjustable transparency both form exterior surfaces of the head-mounted device.

9. The head-mounted device defined in claim 1, wherein the portion of the sidewall structures having the adjustable transparency comprises an electrochromic layer.

10. The head-mounted device defined in claim 1, wherein the portion of the sidewall structures having the adjustable transparency comprises a liquid crystal layer.

11. The head-mounted device defined in claim 1, wherein the portion of the sidewall structures having the adjustable transparency comprises stretchable fabric.

12. The head-mounted device defined in claim 1, wherein the portion of the sidewall structures having the adjustable transparency comprises blinds.

13. The head-mounted device defined in claim 1, wherein the portion of the sidewall structures having the adjustable transparency comprises a chamber with transparent walls that is selectively filled with opaque liquid.

14. The head-mounted device defined in claim 1, further comprising:
a camera, wherein the adjustable transparency of the portion of the sidewall structures is configured to be adjusted based on information from the camera.

15. The head-mounted device defined in claim 1, further comprising:
a sensor, wherein the adjustable transparency of the portion of the sidewall structures is configured to be adjusted based on information from the sensor.

16. The head-mounted device defined in claim 1, further comprising:
a button, wherein the adjustable transparency of the portion of the sidewall structures is configured to be adjusted based on information from the button.

17. The head-mounted device defined in claim 1, further comprising:
one or more cameras;
one or more sensors; and
one or more buttons, wherein the adjustable transparency of the portion of the sidewall structures is configured to be adjusted based on information from the one or more cameras, the one or more sensors, and the one or more buttons.

18. A head-mounted device defined in claim 1, further comprising:
a stretchable fabric that overlaps the portion of the sidewall structures that has the adjustable transparency.

19. A head-mounted device having first and second opposing sides, the head-mounted device comprising:
a first structure on the first side of the head-mounted device;
a second structure on the second side of the head-mounted device, wherein the second structure at least partially surrounds a central opening;
a sidewall structure that extends between the first structure and the second structure, wherein the sidewall structure has an adjustable transparency; and
left and right optical modules configured to display images that are viewable through the central opening.

20. The head-mounted device defined in claim 19, wherein the first structure is a rigid front structure, wherein the second structure is a flexible rear structure, and wherein the head-mounted device further comprises:
support posts that couple the rigid front structure to the flexible rear structure.

21. A head-mounted device, comprising:
left and right optical modules configured to display images;
a flexible structure that is configured to conform to a face, wherein the left and right optical modules are viewable through a central opening defined by the flexible structure;
a rigid structure that is separated from the flexible structure by a gap; and
sidewall structures that bridge the gap between the rigid structure and the flexible structure, wherein the sidewall structures comprise a sidewall display that is viewable through the central opening.

22. The head-mounted device defined in claim 21, further comprising:
one or more cameras, wherein the sidewall display is configured to display images captured by the one or more cameras.

23. The head-mounted device defined in claim 21, wherein the sidewall display has a lower resolution than a display for at least a selected one of the left and right optical modules and wherein the sidewall display has a higher refresh rate than the display for at least the selected one of the left and right optical modules.
